(19) United States
(12) Patent Application Publication
(10) Pub. No.: US 2004/0205157 A1
(43) Pub. Date: Oct. 14, 2004

(54) System, method, and computer program product for realtime profiling of web site visitors

(76) Inventors: Eric Bibelnieks, Ogema, WI (US); David A. Selby, North Boarhunt Near Fareham (GB); Vincent Thomas, Severna Park, MD (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 10/062,105

(22) Filed: Jan. 31, 2002

(51) Int. Cl. G06F 15/16; G06F 17/24

(52) U.S. Cl. 709/218; 709/231; 715/501.1

(57) ABSTRACT

Business intelligence techniques and well-understood sales processes and techniques are utilized to allow the operator of an interactive sales medium, e.g., a web seller, call center operator, intelligent vending machine operator, etc., to gather information pertaining to a user of the web site from as many sources as possible, including from the user's input at the “touch-point” (the PC, kiosk, PDF connected to the Web; an ATM; an intelligent vending machine). Content is selected and displayed that, in a less-than-apparent manner, elicits information from the user regarding his/her proclivities, purchasing habits, demographics, etc., and this information is combined with other data from other sources (call-center records, survey information, store purchases, etc.). This enables the sales medium operator to gain knowledge of the particular characteristics of individuals and permits a structured sales process and/or content delivery process to be tailored to that individual and presented to them via the web site.

### BACKGROUND OF THE INVENTION

1. Field of the Invention

This invention relates to the analysis and display of content to users in an interactive communications medium such as the World Wide Web, and more particularly, to the gathering and use of clickstream data or other data pertaining to use of the medium by users to enable realtime profiling of the users for the purpose of customizing of content such as advertising to be delivered to a particular user.

2. Description of the Related Art

The recent explosion in the use of the World Wide Web (hereinafter “the Web”) has created numerous opportunities for content providers such as advertisers and sellers of products and services to display and sell to consumers. It is becoming apparent, however, that advertising and sales techniques that in the past were practiced by virtually all advertisers and sellers do not necessarily apply to advertising and sales on the Web.

Take, as an example, the sale of shoes. Under the pre-Web “bricks and mortar” model, in response to a query from a consumer indicating a desire for brown shoes, the salesperson might deliberately show the customer three different pairs of brown shoes ranging in price from low, to medium, to high. The potential purchaser would study the three pairs of shoes and, without overtly saying so, identify a certain acceptable price range by selecting one of the pairs to try on. In this manner, a salesperson can quickly home in on the price range acceptable to the purchaser without asking the question “How much are you willing to spend?”. This gives the salesperson valuable information about the customer's “price sensitivity” and allows the salesperson to, for example, show the purchaser additional items at or close to that price range in the hope that additional sales can be made. Through this direct interaction with the customer, the salesperson can gain valuable “business intelligence” about customers that assists the salesperson in tailoring a sales strategy to that particular customer. For example, the salesperson can get a feel for the education level, aversion to risk, personal taste, interests, etc. of the customer and modify sales techniques to suit these characteristics.

In a Web environment, there is no salesperson to process this information. While a purchaser may be shown three different pairs of brown shoes on a website of an “e-tailer,” ranging in price from low, to medium, to high, the fact that the purchaser selected one of the pairs of shoes for purchase, or for further evaluation (e.g., by clicking on a photograph of the shoes), is typically unused by the website. In other words, where in the bricks-and-mortar sales environment, a salesperson, after identifying the purchaser's price range, may use this information and other information gleaned from the direct interaction with the customer (e.g., education level, impulsiveness, etc.) to show the potential purchaser other shoes that they might be prone to purchase, in the Web environment, no such direct interaction is available.

Collaborative filtering is a well-known concept that has been used in an attempt to introduce bricks-and-mortar types of sales techniques to a Web environment. In collaborative filtering, customers are grouped into “communities” based on the content they have viewed or purchases they have made, and then recommendations are made to them based on content viewed by other community members, or purchases made by other community members. An example of collaborative filtering is what is referred to herein as the “customers who bought” feature used by Amazon.com. Amazon.com is an online bookseller that presents Web users with the ability to search their website for books by title, subject matter, key word, etc. When a purchaser selects a particular book title to view or purchase, the purchaser is also presented with a list of other books purchased by customers who bought the book title being viewed by the purchaser. Specifically, Amazon.com maintains a database of purchasers associated with the books they have purchased from Amazon and when a purchaser goes to buy a particular book, the collaborative filtering engine identifies a group of customers whose past purchases is most representative of the purchase(s) being considered by the current purchaser, and from all the books the group of similar customers have bought and the purchaser has not, the most prevalent are presented as a recommendation to the purchaser.

The collaborative filtering used by Amazon.com and others is an interesting tool and does provide some ability to present to a potential purchaser information related to merchandise that may be of interest to them. However, the concept is narrowly focused; it is based upon the tendencies of a particular “community,” defined in the Amazon.com example as those purchasers of a particular book title. Current Web sales techniques lack the ability to analyze and process multiple aspects of a purchaser and then steer that purchaser towards a purchase based upon analysis of these multiple traits, particularly traits that typically require observations by a salesperson or other active participant in the transaction to discern.

Accordingly, it would be desirable to have available to a seller using an interactive sales medium (e.g., the World Wide Web, call centers, intelligent vending machines, etc.) the ability to define their customers by a rich set of variables that identify specific traits of each customer so that the customers can be profiled in real time and allow the customers to be segmented according to these traits, so that the traits can be taken into account when displaying current and future content such as advertising and/or sales information to them.

### SUMMARY OF THE INVENTION

The present invention applies business intelligence techniques and well-understood sales processes and techniques to allow the operator of an interactive sales medium, e.g., a web seller, call center operator, intelligent vending machine operator, etc., to gather information pertaining to a user of the web site from as many sources as possible, including from the user's input at the “touch-point” (the PC, kiosk, PDF connected to the Web; an ATM; an intelligent vending machine). Content is selected and displayed that, in a less-than-apparent manner, elicits information from the user regarding his/her proclivities, purchasing habits, demographics, etc., and this information is combined with other data from other sources (call-center records, survey information, store purchases, etc.). This enables the sales medium operator to gain knowledge of the particular characteristics of individuals and permits a structured sales process and/or content delivery process to be tailored to that individual and presented to them via the web site.

The invention comprises a method of customizing content delivered to users of an interactive content delivery system, such as the World Wide Web, a tree-system in a phone call-in center, and the like. The method includes the steps of accessing a stored user profile for an active user; presenting content to the active user; identifying user characteristics based on the active user's interaction with the presented content and storing data corresponding to the identified user characteristics in a user session profile; updating the active user's user profile with data stored in the user session profile; and presenting subsequent content to the user based on the updated user profile.

In one embodiment, the interactive content delivery system comprises the World Wide Web, and the content presented to the active user comprises multiple links to alternative content choices. In another embodiment, the interactive content delivery system comprises a telephone call center, and the content presented to the active user comprises multiple paths to alternative content choices. It is understood that the processes and methods described herein are applicable to any interactive sales medium, regardless of the particular touch-point used for the interaction.

### BRIEF DESCRIPTION OF THE DRAWINGS

FIG. 1 is a flowchart illustrating preliminary steps to be taken to set up a website for use in accordance with the present invention;

FIG. 2 is a flowchart illustrating an example of the operation of a website developed in accordance with the present invention;

FIG. 3 illustrates an exemplary data processing network in which the present invention may be practiced; and

FIG. 4 is a block diagram of a processing device in accordance with the present invention.

### DETAILED DESCRIPTION OF THE PREFERRED EMBODIMENTS

It will be understood that each element of the illustrations, and combinations of elements in the illustrations, can be implemented by general and/or special purpose hardware-based systems that perform the specified functions or steps, or by combinations of general and/or special-purpose hardware and computer instructions.

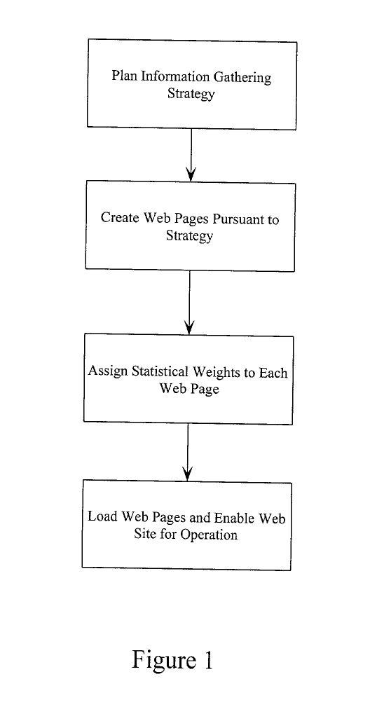

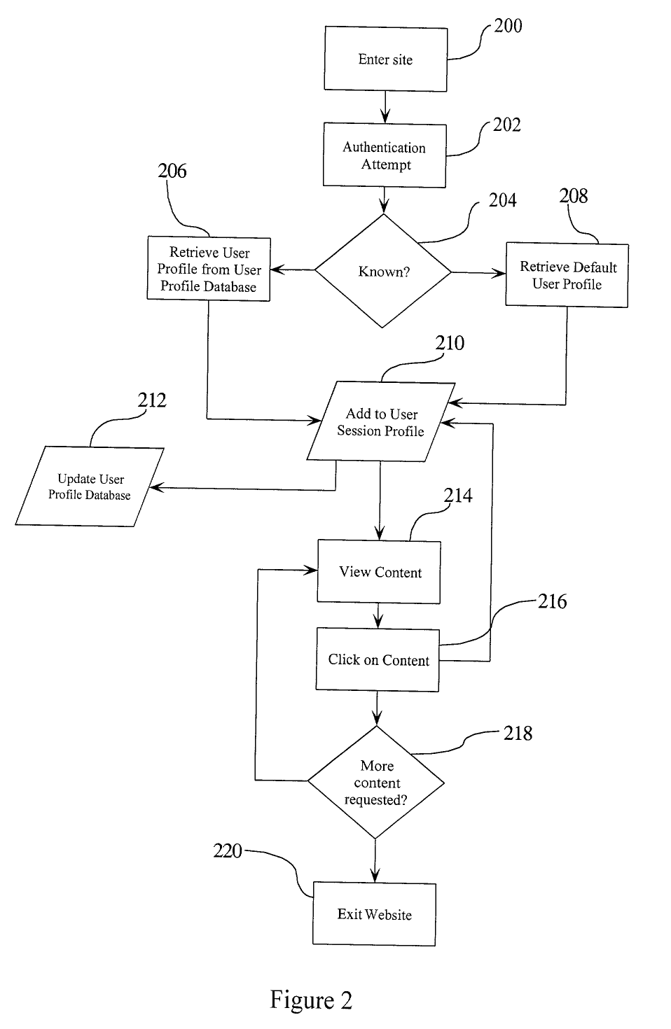

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-2 support combinations of means for performing the specified functions, combinations of steps for performing the specified functions, and program instruction means for performing the specified functions.

FIG. 1 is a flowchart illustrating preliminary steps to be taken to set up the web site to operate in accordance with the present invention. Referring now to FIG. 1, at step 102, the web developer plans an information-gathering strategy for the website. When deciding on page content, significant thought must go into content selection so that information about the users of the site can be gleaned from the selections. The web developer consults the website sales professionals and/or website owner to determine conventional sales strategies that would traditionally be applied to sales of the products or services, and to find out what kind of information a salesperson might typically want to know to develop a sales strategy for a customer.

This information is considered during the information-gathering strategy planning step, as are methods of obtaining the information. For example, rather than simply displaying all available products on a single page, the web site operator might choose to show three products of a low, medium, and high price range, respectively; the choice made by the user will then give the web site operator an idea of the price range that the user will find acceptable. Likewise, the website operator might want to identify personality traits of users by presenting them with information that will elicit a response that identifies these traits. For example, by placing various news or feature articles of interest on the initial page, personality traits and/or interests of the user may be identified based on which of the articles are clicked, as discussed in more detail below.

In addition to these web-based methods of gathering information, more traditional methods may also be used to gather this information, such as using survey information, prior sales information, information obtained from phone calls, and the like, all of which are combined in tailoring the web page to present the customer with a sales presentation that will likely increase the likelihood that the customer will buy, and that will possibly increase the volume of sales as well. For example, many retailers, such as Barnes & Noble, have both bricks-and-mortar and web-based sales avenues; thus they may have access to significant additional information regarding a consumer beyond that obtained by strictly web-based methods.

At step 104, the web page developer takes the information identified during the information gathering strategy step 102 and creates a web page that reflects this strategy. Initial web page content is written and the appropriate links to additional web pages are written in accordance with known techniques.

At step 106, the web site developer assigns a statistical weight value to each potential selection, to assist in creating and/or fine-tuning a “user profile” for each user as described in more detail below. For example, if there is a clickable link to an article about make-up and a second clickable link to an article about baldness, the web operator might assign to the selection of the make-up article a statistical weight value indicating that there is a 90% probability that the user is a female and only a 10% probability that the user is male. Similarly, the selection of the article on baldness might be assigned a statistical weight value indicating a 95% probability that the user is male and a 5% probability that the user is female. Once the information gathering strategy has been decided upon, the web pages created pursuant to the strategy have been completed, and the statistical weights have been assigned to each web page, at step 108 the website developer loads the web pages and enables the website for operation in the usual manner.

FIG. 2 is a flowchart illustrating an example of the operation of a website performing the operations of the present invention. At step 200 a user enters the website of an e-tailer or other website operator whose website is set up to operate in accordance with the present invention. At step 202, an attempt is made to authenticate or otherwise identify the customer entering the site, to see if there is any historical information available for this user. Thus, if the customer is a previous user who has registered on the website, significant demographic, prior purchase, and related information may already be available, thus allowing the website visit to be tailored to the individual from the beginning. For example, if the person has registered with the site and inputs a password and user name, at step 204 the customer is identified as a known customer and the process proceeds to step 206 where a user profile for the customer is obtained from a user profile database. The user profile database is simply a storage database where user profiles for all users of the website are stored for the website.

Once the retrieved user profile has been obtained, a user session profile is established for the user at step 210, beginning with the user profile obtained in step 206. The user session profile contains the stored user profile (if any) and any data added by the user for the current web session only. Thus, as a user makes selections that identify additional characteristics of the user, they are added to that user's session profile, thereby evolving the user's profile further based on this new information. At step 212, all data added to the user session profile is also added to the user profile database to keep it up to date with the newly evolved information.

If it is determined at step 204 that the user is unidentified and/or does not have a stored user profile, at step 208 a default user profile is retrieved, e.g., from the user profile database or from a default user profile stored locally on the user's computer or elsewhere. The default user profile is used to establish the initial user session profile at step 210. The default values are set based on, for example, general statistics (e.g., there is a 50% probability that the web user is male, and a 50% probability that the web user is female; thus, equal amounts of male and female content may be provided at the beginning of the website visit). It is also possible that traffic-related historical statistics may already be available for the site (e.g., it may already be known that 75% of the people who initially visit this site are women) and thus assumptions can be made about the user and initial website content may be tailored accordingly.

At step 214, the customer views content on the website. The website visitor is brought to the initial page, e.g., the home page of the website, where he/she is presented with the initial content. In accordance with the present invention, the content has been selected carefully so that the selections made by the user, at least at this initial stage, are as much designed to elicit information about the user as they are to sell products or services to the user.

At step 216, the customer selects content from the page being viewed by clicking on a content selection. This selection is recorded and added to the user's session profile 210, and using a rules engine or other known discrimination process, the selection is analyzed and a subsequent page is displayed to the viewer based on the selection. Known analysis techniques can be used; for example, during analysis, the resulting behaviors from all of the web traffic are observed for a certain period of time. A set of reports can then be developed that identify and measure the number of different paths traveled on subsequent clicks to reach a particular piece of content, and identify the associated results, (e.g., buy from website; no buy from website; visited website for 10 pages and made a subsequent purchase at a physical store, etc.).

At step 218, a determination is made as to whether or not additional content is requested to be viewed. If additional content is to be viewed, the process reverts back to step 214 where the content is viewed and selections are made at step 216. If the additional content is not requested to be viewed, at step 220 the process is completed and the customer exits the website.

In accordance with the present invention, website content is deliberately selected so that selections made by clicking on elements of a web page will covertly give the website owner information about the website visitor. The selections made by the website visitor are recorded and analyzed using known sales and business intelligence processes and this information is stored in the user profile for that visitor.

With each click, the information learned about the user is stored in a database to update the customer information for the current website visit and for future website visits. If the user is a registered user, the information is simply stored in a database associated with the user's user name and password. Alternatively, if the user is an anonymous visitor, cookies can be used in a well known manner to associate the anonymous user with their information database file.

With access to this current, up-to-date, real time information concerning characteristics of users, rules engines or any programming logic capable of implementing real-time “decisions” can be used on a real time basis to make decisions regarding content to be presented to the user at any time, either immediately or in the future. This instantaneous feedback and modification based on feedback enables websites and other interactive media to be used in much the same manner as live interaction enables instant decision-making on the part of a salesman or other human interacting with a potential consumer

Using the present invention, with each click more information is gained and used for that visit as well as future visits. Accordingly, the information regarding the user is continually refined and the user will be provided with content more relevant to their interests and less “noise” (content that is uninteresting to the user). The result is a more useful web experience for the user and a more productive sales environment for the seller.

As noted in the example above, a website visitor might be given a choice of three similar products in three distinct price ranges, and based upon which of the three products the user clicks on, a determination can be made about the user's tendencies towards price sensitivity. Likewise, news items or informational items may be placed on the page, and depending upon the subject matter of the content of these news items and/or informational items, information may be ascertained about the user's age, sex, interests, political views, and the like. For example, if, on the same page, articles are placed about city life and outdoor activities, and if the user clicks on the outdoor activities content, it is reasonable to assume that the website visitor enjoys outdoor activities. Based upon this knowledge, the website might bring the website visitor to a page designed to sell items related to outdoor activities, such as hiking boots, mountain vacations, or camping equipment. Similarly, content which has a high probability of being associated with a particular gender (e.g., make-up for women; power tools for men) can be utilized to ascertain the probable gender of the website visitor, thereby allowing the subsequent “sales presentations” to be directed to that particular gender.

While the above-described examples illustrate the initial customer information being derived from login information, cookies, and the like, it is understood that information pertaining to the characteristics of the user of the site can be obtained from any informational source for which data can be stored in a database. For example, if a particular website maintains a database of information obtained by callers calling a “help-line” or by persons responding to a written survey, this information can also be stored in the user profile database so that when the user log onto the website, all of this additional information is available for use by the system.

The above-described steps can be implemented using standard well-known programming techniques. The novelty of the above-described embodiment lies not in the specific programming techniques but in the use of the steps described to achieve the described results. By using the process of the present invention, knowledge of the needs and wants of a customer or other user of the interactive medium are managed to predict what the customer/user will want to see or purchase, as opposed to other systems that look at the wants and needs of others to predict what the customer/user might want to see or purchase.

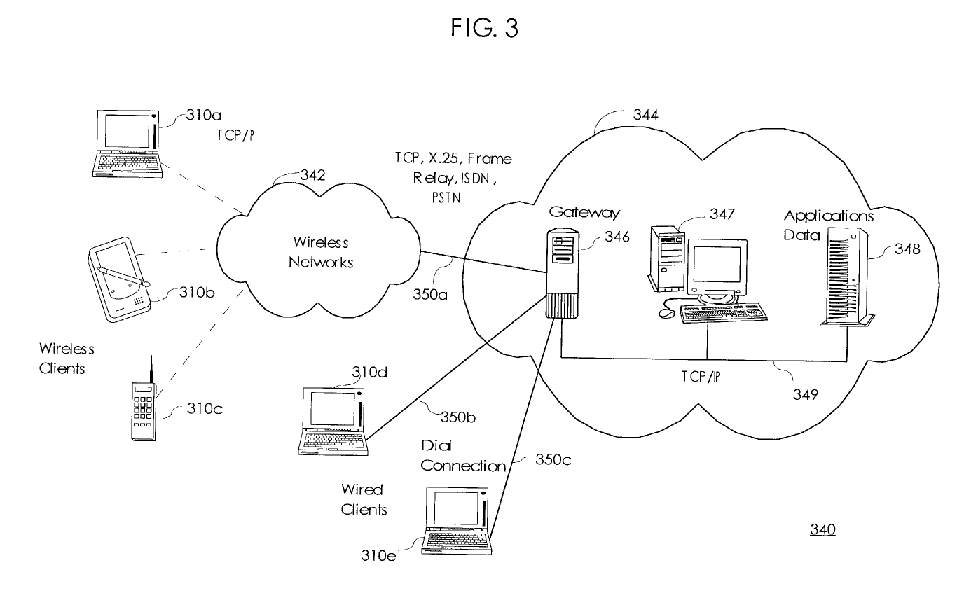

FIG. 3 illustrates an exemplary data processing network 340 in which the present invention may be practiced. The data processing network 340 may include a plurality of individual networks, such as wireless network 342 and network 344, each of which may include a plurality of individual workstations/devices, e.g. 310a, 310b, 310c. Additionally, as those skilled in the art will appreciate, one or more LANs may be included (not shown), where a LAN may comprise a plurality of intelligent workstations coupled to a host processor.

The networks 342 and 344 may also include mainframe computers or servers, such as a gateway computer 346 or application server 347 (which may access a data repository 348). A gateway computer 346 serves as a point of entry into each network 344. The gateway computer 346 may be preferably coupled to another network 342 by means of a communications link 350a. The gateway computer 346 may also be directly coupled to one or more workstations, e.g 310d, 310e using a communications link 350b, 350c. The gateway computer 346 may be implemented using any appropriate processor, such as IBM's Network Processor. For example, the gateway computer 346 may be implemented using an IBM pSeries (RS/6000) or xSeries (Netfinity) computer system, an Enterprise Systems Architecture/370 available from IBM, an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390,” “Application System/400,” and “AS/400” are registered trademarks of IBM.) These are merely representative types of computers with which the present invention may be used.

The gateway computer 346 may also be coupled 349 to a storage device (such as data repository 348). Further, the gateway 346 may be directly or indirectly coupled to one or more workstations/devices 310d, 310e, and servers such as application server 347.

Those skilled in the art will appreciate that the gateway computer 346 may be located a great geographic distance from the network 342, and similarly, the workstations/devices may be located a substantial distance from the networks 342 and 344. For example, the network 342 may be located in California, while the gateway 346 may be located in Texas, and one or more of the workstations/devices 310 may be located in New York. The workstations/devices 310 may connect to the wireless network 342 using a networking protocol such as the Transmission Control Protocol/Internet Protocol (“TCP/IP”) over a number of alternative connection media, such as cellular phone, radio frequency networks, satellite networks, etc. The wireless network 342 preferably connects to the gateway 346 using a network connection 350a such as TCP or UDP (User Datagram Protocol) over IP, X.25, Frame Relay, ISDN (Integrated Services Digital Network), PSTN (Public Switched Telephone Network), etc. The workstations/devices 410 may alternatively connect directly to the gateway 346 using dial connections 350b or 350c. Further, the wireless network 342 and network 344 may connect to one or more other networks (not shown), in an analogous manner to that depicted in FIG. 3.

The present invention may be used on a client computer or server in a networking environment, or on a standalone workstation. (Note that references herein to client and server devices are for purposes of illustration and not of limitation: the present invention may also be used advantageously with other networking models.) When used in a networking environment, the client and server devices may be connected using a “wireline” connection or a “wireless” connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The workstation or client computer may be any type of computer processor, including laptop, handheld or mobile computers; vehicle-mounted devices; desktop computers; mainframe computers; etc., having processing (and, optionally, communication) capabilities. The server, similarly, can be one of any number of different types of computer which have processing and communication capabilities. These techniques are well known in the art, and the hardware devices and software which enable their use are readily available.

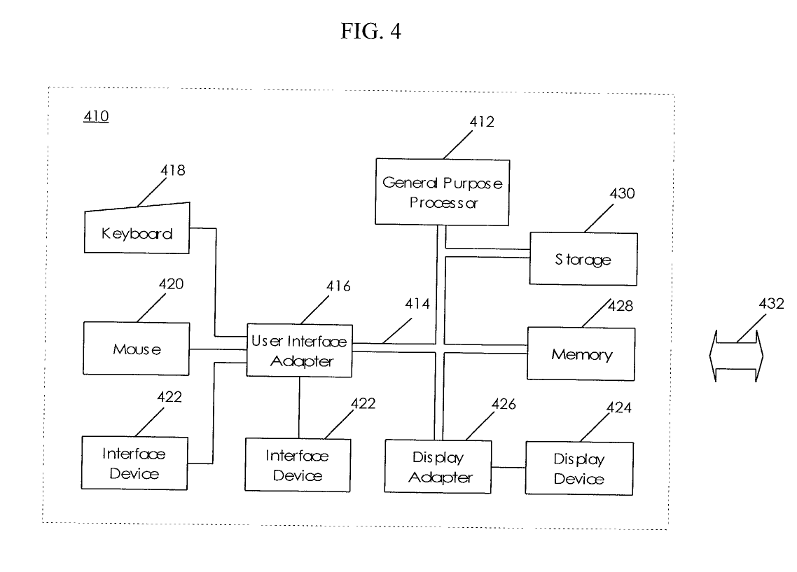

FIG. 4 is a block diagram of a processing device 410 in accordance with the present invention. The exemplary processing device 410 is representative of workstation 310a or server 346 of FIG. 3, as discussed above. This block diagram represents hardware for a local implementation or a remote implementation.

As is well known in the art, the workstation of FIG. 4 includes a representative processing device, e.g. a single user computer workstation 410, such as a personal computer, including related peripheral devices. The workstation 410 includes a general purpose microprocessor 412 and a bus 414 employed to connect and enable communication between the microprocessor 412 and the components of the workstation 410 in accordance with known techniques. The workstation 410 typically includes a user interface adapter 416, which connects the microprocessor 412 via the bus 414 to one or more interface devices, such as a keyboard 418, mouse 420, and/or other interface devices 422, which can be any user interface device, such as a touch sensitive screen, digitized entry pad, etc. The bus 414 also connects a display device 424, such as an LCD screen or monitor, to the microprocessor 412 via a display adapter 426. The bus 414 also connects the microprocessor 412 to memory 428 and long-term storage 430 (collectively, “memory”) which can include a hard drive, diskette drive, tape drive, etc.

The workstation 410 may communicate with other computers or networks of computers, for example, via a communications channel or modem 432. Alternatively, the workstation 410 may communicate using a wireless interface at 432, such as a CDPD (cellular digital packet data) card. The workstation 410 may be associated with such other computers in a LAN or a wide area network (WAN), or the workstation 410 can be a client in a client/server arrangement with another computer, etc. All of these configurations, as well as the appropriate communications hardware and software, are known in the art.

The above examples are given for the purpose of example only. It is understood that there will be numerous variations as to the type of information desired for a particular sale and the selection of “click-choices” for a user to be presented with in order to ascertain proclivities with respect to the desired characteristics. These variations are considered part of the present application and covered by the appended claims.

In addition, although the present invention has been described with respect to a specific preferred embodiment thereof, various changes and modifications may be suggested to one skilled in the art and it is intended that the present invention encompass such changes and modifications as fall within the scope of the appended claims. For example, while the present invention as described herein is described with reference to selling items on a website, it is understood that the same techniques can be used for gaining information unrelated to sales, for example, to research; handling of parts in a parts inventory system (build a profile of parts always requisitioned by an individual, then use this to tailor the information/links presented to first show him/her parts typically used for day-to-day work, rather than having to wade through the entire database); improving customer service by shortening the length of a visit by providing content more quickly; lengthening a visit on a website by showing more content along the path to the ultimate destination (similar to the manner in which stores design store layouts to make shoppers visit more departments on their way to an ultimate destination in the store).

We claim:

1. A method of customizing content delivered to users of an interactive content delivery system, comprising the steps of:
accessing a stored user profile for an active user;
presenting content to said active user;
identifying user characteristics based on said active user's interaction with said presented content and storing data corresponding to said identified active user's characteristics in a user session profile;
updating said active user's user profile with data stored in said user session profile; and
presenting subsequent content to said user based on said updated user profile.

2. A method as set forth in claim 1, wherein said interactive content delivery system comprises the World Wide Web, and wherein said content presented to said user comprises multiple links to alternative content choices.

3. A method as set forth in claim 1, wherein said interactive content delivery system comprises a telephone call center, and wherein said content presented to said user comprises multiple paths to alternative content choices.

4. A method as set forth in claim 1, wherein said stored user profile comprises data relating to one or more of said active user's interests, purchasing habits, demographics.

5. A method as set forth in claim 4, wherein said stored user profile data is derived from prior web activity of said active user.

6. A method as set forth in claim 4, wherein said stored user profile data is derived from prior purchasing activity of said active user.

7. A method as set forth in claim 4, wherein said stored user profile data is derived from survey information provided by said active user.

8. A method as set forth in claim 4, wherein said stored user profile data is derived from information obtained from personal contacts between said active user and said provider of said interactive content.

9. A method as set forth in claim 4, wherein said stored user profile data is derived from one or more of prior web activity of said active user, prior purchasing activity of said active user, survey information provided by said active user and information obtained from personal contacts between active user and said provider of said interactive content.

10. A method as set forth in claim 1, wherein said content presented to said active user comprises multiple links to alternative content choices.

11. A method as set forth in claim 1, wherein said content presented to said active user comprises multiple paths to alternative content choices.

12. A system of customizing content delivered to users of an interactive content delivery system, comprising:
means for accessing a stored user profile for an active user;
means for presenting content to said active user;
means for identifying user characteristics based on said active user's interaction with said presented content and storing data corresponding to said identified active user's characteristics in a user session profile;
means for updating said active user's user profile with data stored in said user session profile; and
means for presenting subsequent content to said user based on said updated user profile.

13. A system as set forth in claim 12, wherein said interactive content delivery system comprises the World Wide Web, and wherein said content presented to said user comprises multiple links to alternative content choices.

14. A system as set forth in claim 12, wherein said interactive content delivery system comprises a telephone call center, and wherein said content presented to said user comprises multiple paths to alternative content choices.

15. A system as set forth in claim 12, wherein said stored user profile comprises data relating to one or more of said active user's interests, purchasing habits, demographics.

16. A system as set forth in claim 15, wherein said stored user profile data is derived from prior web activity of said active user.

17. A system as set forth in claim 15, wherein said stored user profile data is derived from prior purchasing activity of said active user.

18. A system as set forth in claim 15, wherein said stored user profile data is derived from survey information provided by said active user.

19. A system as set forth in claim 15, wherein said stored user profile data is derived from information obtained from personal contacts between active user and said provider of said interactive content.

20. A system as set forth in claim 15, wherein said stored user profile data is derived from one or more of prior web activity of said active user, prior purchasing activity of said active user, survey information provided by said active user and information obtained from personal contacts between active user and said provider of said interactive content.

21. A system as set forth in claim 12, wherein said content presented to said active user comprises multiple links to alternative content choices.

22. A system as set forth in claim 12, wherein said content presented to said active user comprises multiple paths to alternative content choices.

23. A computer program product of customizing content delivered to users of an interactive content delivery system, the computer program product comprising a computer-readable storage medium having computer-readable program code embodied in the medium, the computer-readable code comprising:
computer-readable program code that accesses a stored user profile for an active user;
computer-readable program code that presents content to said active user;
computer-readable program code that identifies user characteristics based on said active user's interaction with said presented content and stores data corresponding to said identified active user's characteristics in a user session profile;
computer-readable program code that updates said active user's user profile with data stored in said user session profile; and
computer-readable program code that presents subsequent content to said user based on said updated user profile.

24. A computer program product as set forth in claim 23, wherein said interactive content delivery system comprises the World Wide Web, and wherein said content presented to said user comprises multiple links to alternative content choices.

25. A computer program product as set forth in claim 23, wherein said interactive content delivery system comprises a telephone call center, and wherein said content presented to said user comprises multiple paths to alternative content choices.

26. A computer program product as set forth in claim 23, wherein said stored user profile comprises data relating to one or more of said active user's interests, purchasing habits, demographics.

27. A computer program product as set forth in claim 26, wherein said stored user profile data is derived from prior web activity of said active user.

28. A computer program product as set forth in claim 26, wherein said stored user profile data is derived from prior purchasing activity of said active user.

29. A computer program product as set forth in claim 26, wherein said stored user profile data is derived from survey information provided by said active user.

30. A computer program product as set forth in claim 26, wherein said stored user profile data is derived from information obtained from personal contacts between active user and said provider of said interactive content.

31. A computer program product as set forth in claim 26, wherein said stored user profile data is derived from one or more of prior web activity of said active user, prior purchasing activity of said active user, survey information provided by said active user and information obtained from personal contacts between active user and said provider of said interactive content.

32. A computer program product as set forth in claim 23, wherein said content presented to said active user comprises multiple links to alternative content choices.

33. A computer program product as set forth in claim 23, wherein said content presented to said active user comprises multiple paths to alternative content choices.
